(19) United States
(12) Patent Application Publication
(10) Pub. No.: US 2009/0162599 A1
(43) Pub. Date: Jun. 25, 2009

(54) Thermoacoustic barrier vacuum panel

(76) Inventor: Michael John Rickards, Penzance (GB)

Correspondence Address: M. J. Rickards, 4 Castle Drive, Praa Sands, PENZANCE, TR20 9TF, GB

(21) Appl. No.: 12/214,775

(22) Filed: Jun. 23, 2008

(30) Foreign Application Priority Data
Dec. 21, 2007 (GB) GB0724949.3

(51) Int. Cl. B32B 1/06

(52) U.S. Cl. 428/69

(57) ABSTRACT

A heat and sound barrier panel comprising an upper pane (1) with downward flanges (4) to its four sides and a lower pane (2) with upward flanges to its four sides (5) separated by insulating rods (3) of sufficient height to leave a gap (6) between the upper (4) and lower (5) flanges with the gap (6) hermetically sealed with a perimeter film (7) and the enclosed space evacuated to less than 1 Pa.

### CROSS-REFERENCE TO RELATED APPLICATIONS

The invention described herein is the subject of United Kingdom Patent Application GB 0724949.3, 12.27.2008. The following Patents are relevant to this invention: GB2440598 A, 08-01-2006; WO 01/21924 A, 09-21-2000; EP0421239 A3, 09-25-90; WO 2004/025064 A,04-17-2003; DE2746061 A, 10-13-1977; WO 2005/057077 A, 12-12-2003 and GB 2399101 A, 03-04-2003

### STATEMENT REGARDING FEDERALLY SPONSORED RESEARCH OR DEVELOPMENT

Not Applicable

### REFERENCE TO SEQUENCE LISTING.

Not Applicable

### BACKGROUND OF THE INVENTION

Heat and sound insulation barriers have been studied for many years and some remarkable advances have been made particularly in the use of a vacuum in thermal insulation structures. However, vacuum insulation panels, VIPs, are difficult to manufacture, often have to be made to specified dimensions, and their internal supporting rigid cores and outer plastic film covers are easily damaged with rough handling. In addition they require internal gas absorbing chemicals to ensure the vacuum and therefore the insulation value is maintained over long periods.

Sound insulation materials, however, still require the sound wave to pass through the insulating material and in order to lose energy through inelastic expansions and contractions. Such materials have invariably shown greater sound attenuation, up to 35 dB, at the higher audio frequencies and offer relatively poor damping, 10 to 15 dB, at lower and more annoying frequencies. The increasing and oppressive nuisance of road traffic and aircraft noise has spurred interest in the development of improved noise reduction materials for use both at the source of the noise and as a barrier to the transmission of that noise into populated areas such as dwellings, public halls and schools.

### BRIEF SUMMARY OF THE INVENTION

The thermoacoustic barrier described in this invention offers something completely new both in the field of thermal insulation and in noise control. By constructing a vacuum panel with the upper and lower sheets separated by narrow insulating rods and sealing the panel with a very low gas permeability film the panel can maintain vacuum integrity over many years and the device offers a thermal resistance in excess of R100/in, so high in fact that it is extremely difficult to measure.

The sound barrier efficiency of this invention opens new vistas in the field of noise attenuation. Not only is the sound rejection level astonishingly high, over 65 dB is attainable, but in addition the attenuation remains at the same level throughout the audio frequency range. This is an unprecedented advance in acoustic engineering and it is based on the simple fact that the sound wave arriving at, for instance, the upper sheet of the vacuum panel has nowhere to go and consequently is reflected back in the direction of the source. This rejection applies equally to all audio frequencies and provides an effective defence against the nuisance of noise from urban traffic, low flying aircraft and loud entertainment music.

The advance in acoustics and heat insulation offered by this invention is all the more remarkable in that the vacuum panels can be made from inexpensive, readily available materials and the design is entirely suited to an automated manufacturing process. Furthermore the panels are robust and not easily damaged either in transport or use.

The present invention is illustrated in FIG. 1 as a square pane comprising an upper (1) pane with a downward flange (4) to its four sides and a lower (2) pane having an upwards flange (5) to its four sides the panes being separated by cylindrical rods (3), having low thermal conductivity, placed one at each corner and one or more along each side of the panel. The rods having sufficient height to ensure a gap (6) between the upper (4) and lower (5) flanges and the panes do not make contact when inwardly flexed under atmospheric pressure. The panel is then hermetically sealed with a thin perimeter film (7) having low thermal conductivity and the space enclosed then evacuated to less than 1 Pa.

This invention offers the following advantages:
1. Extremely low thermal transmission when made from suitable materials.
2. High sound rejection maintained equally at high and low frequencies.
3. Easily manufactured, at low cost, from readily available materials.
4. The insulating efficiency can be maintained for more than 10 years.
5. Suitable for low temperature applications such as refrigeration.

### BRIEF DESCRIPTION OF THE SEVERAL VIEWS OF THE DRAWING

FIG. 1 illustrates the basic construction of the vacuum panel with a partial cut away of the upper panel to show the supporting rods and sealing film.

FIG. 2 is a similar view as shown in FIG. 1 but incorporating 12 supporting rods instead of 8.

FIG. 3 is a similar view as shown in FIG. 1 but incorporating 16 supporting rods instead of 8.

FIG. 4 shows a vacuum panel having a domed upper sheet, partially cut away to show the 16 supporting rods and sealing film.

FIG. 5 shows a vacuum panel having a triangular shape with the upper sheet, partially cut away to show the 12 supporting rods and sealing film.

FIG. 6 shows a vacuum panel having a trapezium shape with the upper sheet partially cut away to show the 14 supporting rods and sealing film.

FIG. 7 shows a vacuum panel shaped as a regular hexagon with the upper sheet partially cut away to show the 18 supporting rods and sealing film.

### DETAILED DESCRIPTION OF THE INVENTION

The following examples describe the embodiment of this invention:

### EXAMPLE 1

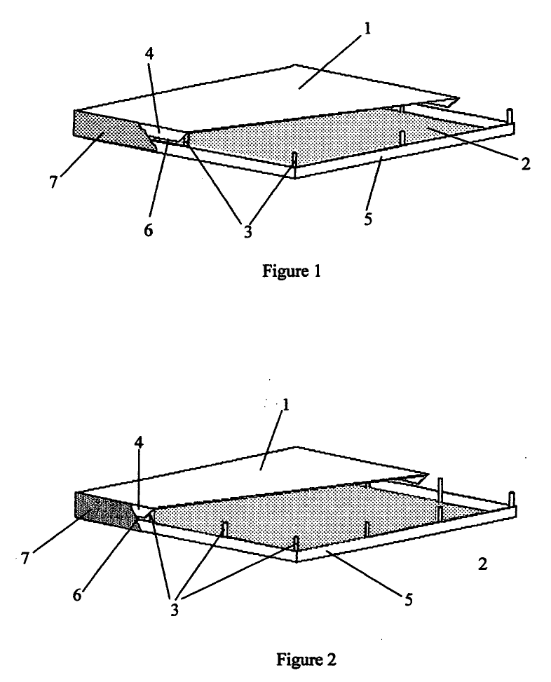

The panel illustrated in FIG. 1 comprises:
a. A square upper (1) pane with downward flange (4) 15 mm high and lower (2) pane with an upward flange also 15 mm high with 400 mm sides all made from single 1 mm thick tempered steel sheet. The corners sealed with epoxy resin.

b. The upper (1) and lower (2) panes are separated by eight 35 mm high 5 mm diameter glass rods (3), one placed at each corner and one midway along each side.

c. The 5 mm gap (6) between the upper and lower perimeter walls sealed with a perimeter film (7) of self adhesive Mylar (polyethelene terephthalate) 35 mm wide and 0.01 mm thick

d. The sealed panel evacuated to less than 1 Pa (0.01 mbar).

This panel had a thermal transmission of 0.0045 WK⁻¹ (effectively a “U” value of 0.028 R-35) and a constant sound rejection level of about 55 dB over the frequency range of 100 to 3200 Hz. This example is typical of panels that can be made commercially. The Mylar film had a coat of aluminium, about 0.0001 mm thick, to counter air seepage into the panel.

### EXAMPLE 2

The panel illustrated in FIG. 2 comprises:
a. A square upper (1) pane with downward flange (4) 15 mm high and lower (2) pane with an upward flange also 15 mm high with 400 mm sides all made from single 1 mm thick tempered steel sheet. The corners sealed with epoxy resin.
b. The upper (1) and lower (2) panes are separated by twelve 35 mm high 3 mm diameter glass rods (3), one placed at each corner and two a third of the way along each side.
c. The 5 mm gap (6) between the upper and lower perimeter walls sealed with a perimeter film (7) of self adhesive Mylar (polyethelene terephthalate) 35 mm wide and 0.01 mm thick.
d. The sealed panel then evacuated to less than 1 Pa (0.01 mbar).

This panel had a thermal transmission of 0.0024 WK⁻¹ (effectively a “U” value of 0.015 or R-65) and a sound rejection level of more thin 60 dB over the frequency range of 100 to 3200 Hz.

### EXAMPLE 3

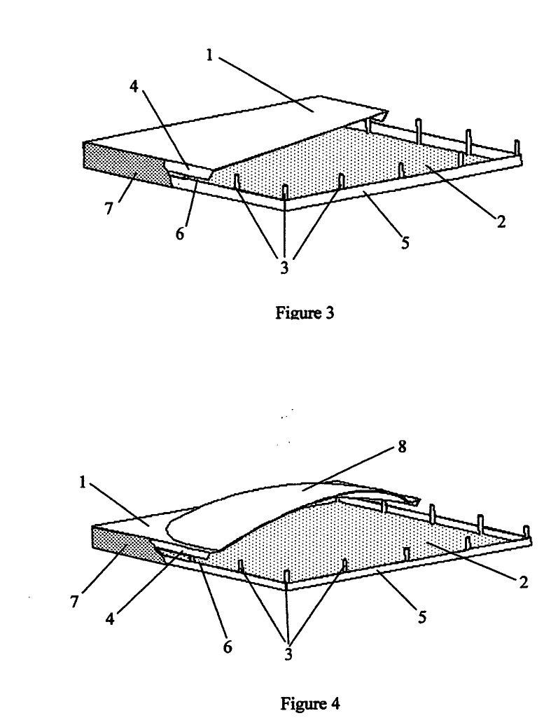

The panel illustrated in FIG. 3 comprises:
a. A square upper (1) pane with downward flange (4) 15 mm high and lower (2) pane with an upward flange also 15 mm high with 400 mm sides all made from single 1 mm thick tempered steel sheet. The corners sealed with epoxy resin.
b. The upper (1) and lower (2) panes are separated by sixteen 35 mm high 3 mm diameter glass rods (3), one placed at each corner and three equally spaced along each side.
c. The 5 mm gap (6) between the upper and lower perimeter walls sealed with a perimeter film (7) of self adhesive Mylar (polyethelene terephthalate) 35 mm wide and 0.01 mm thick.
d. The sealed panel then evacuated to less than 1 Pa (0.01 mbar).

This panel had a thermal transmission of 0.0032 WK⁻¹ (effectively a “U” value of 0.02 or R-50) and a sound rejection level of more than 60 dB over the frequency range of 100 to 3200 Hz.

### EXAMPLE 4

The panel illustrated in FIG. 4 comprises:
a. A square upper (1) pane with downward flange (4) 10 mm high with 400 mm sides made from 0.8 mm thick mild steel sheet and featuring a 370 mm diameter dome, centrally placed and having a height (8) of 50 mm. The corners sealed with epoxy resin.
b. A lower (2) pane with upward flanges 10 mm high with 400 mm sides made from 0.8 mm thick mild steel sheet. The corners sealed with epoxy resin.
c. The upper (1) and lower (2) panes are separated by sixteen 25 mm high 3 mm diameter glass rods (3), one placed at each corner and three equally spaced along each side.
d. The 5 mm gap (6) between the upper and lower perimeter walls sealed with a perimeter film (7) of self adhesive Mylar (polyethelene terephthalate) 25 mm wide and 0.01 mm thick.
e. The sealed panel then evacuated to less than 1 Pa (0.01 mbar).

This panel had a thermal transmission of 0.0045 WK⁻¹ (effectively a “U” value of 0.028 or R-35) and a sound rejection level of more than 60 dB over the frequency range of 100 to 3200 Hz.

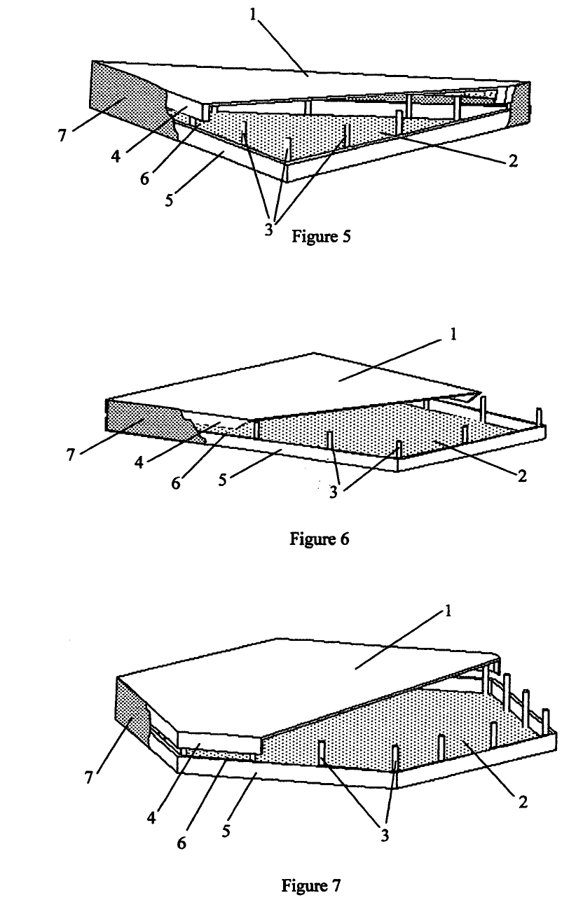

In the above examples the panels were square shaped but some advantages can be obtained with panels of a triangular shape, illustrated in FIG. 5, a trapezium shape, illustrated in FIG. 6 or a hexagonal shape, illustrated in FIG. 7, with upper (1) and lower (2) flanged panes separated by rods (3) to leave a gap (6) sealed by a perimeter film (7) to enable a vacuum of less than 1 Pa to be maintained inside the panel.

The sealing film (7) of Mylar (polyethelene terephthalate) when coated with aluminium provides an effective barrier to air and water vapour seepage into the panel thereby maintaining vacuum integrity over a term of at least ten years. Applying multiple layers of sealing film further reduces the ingress of gases into the evacuated panel.

In the examples the residual air inside the finished panels is reduced to less than 1 Pa (0.01 mbar). This pressure has been found to be sufficiently low to ensure that both sound and heat transmission takes place almost entirely through the rods and sealing film. Radiant energy transmission through the panel is considered to be negligible.

The term ‘low thermal conductivity’ herein applies to substances having a thermal conductivity of less than 50 Wm⁻¹K⁻¹. In the examples given herein the separating rods (3) were made from glass having a thermal conductivity of 1 Wm⁻¹K⁻¹. Other materials such as fused silica, quartz, zirconia and others have similar thermal conductivities.

What I claim as my invention is:

1. A sound and heat barrier comprising square upper and lower panes with opposing flanges separated by rods of low thermal conductivity one placed in the corners of the panes and one or more placed with equal spacing along the sides of the panes and the rods having sufficient height to ensure a gap between the flanges said gap being hermetically sealed with a plastic film of low thermal conductivity and the enclosed space evacuated to less than 100 Pa.

2. A panel as claimed in claim 1 in which one or both panes are domed.

3. A panel as claimed in claim 1 or claim 2 wherein the rods are made of glass.

4. A panel as claimed in any of the preceding claims wherein the separating rods are made of substance having a low thermal conductivity.

5. A panel as claimed in claim 1 or claim 2 wherein the number of rods totals eight or twelve or sixteen.

6. A panel as claimed in any of the preceding claims wherein the upper and lower panes are triangular in shape.

7. A panel as claimed in any of the preceding claims wherein the upper and lower panes are in the shape of a trapezium.

8. A panel as claimed in any of the preceding claims wherein the upper and lower panes are in the shape of a hexagon.

9. A panel as claimed in any of the preceding claims wherein the sealing film is made of polyethelene terephthalate.

10. A panel as claimed in claim 9 wherein the sealing film is made from any plastic having a low thermal conductivity.

11. A panel as claimed in claim 9 wherein the sealing film is coated with a metallic substance and is applied as a single layer or a multiplicity of layers.
